(19) United States
(12) Patent Application Publication
(10) Pub. No.: US 2011/0119125 A1
(43) Pub. Date: May 19, 2011

(54) METHOD AND SYSTEM FOR ONE TAG TRAFFICKING IN DISPLAY ADVERTISING TO ACHIEVE PERSONALIZED AD EXPERIENCES AT SCALE

(76) Inventors: Pradeep S. JAVANGULA, San Jose, CA (US); Sandeep A. Nawathe, Sunnyvale, CA (US); Nipun Kumar Nair, Redwood City, CA (US); Bhavin B. Doshi, Milpitas, CA (US)

(21) Appl. No.: 12/948,508

(22) Filed: Nov. 17, 2010

Related U.S. Application Data
(60) Provisional application No. 61/262,094, filed on Nov. 17, 2009.

(51) Int. Cl. G06Q 30/00

(52) U.S. Cl. 705/14.43; 705/14.49

(57) ABSTRACT

A method and system for trafficking one-to-one display ad campaigns centers around a Dynamic Ad Server that generates an advertising creative experience dynamically by assembling different ad subcomponents on the fly, selecting subcomponents based on publisher, user or media parameters submitted to the Ad Server at the time an ad impression is to be served. A business rules engine allows a marketer to author natural-language business rules. Using such system, campaigns can be designed and implemented wherein association of placements to creative tags is only per-size per-campaign, necessitating set-up of only one placement per distinct site in a media plan. By accommodating the rules via dynamic ad placement, a marketer's intent may be fully satisfied. Time required for set-up and launch is dramatically reduced and maintenance and optimization is infinitely scalable.

### CROSS REFERENCE TO RELATED APPLICATION

This Application claims benefit of U.S. provisional patent application Ser. No. 61/262,094, filed Nov. 17, 2009, the entirety of which is incorporated herein by this reference thereto.

### BACKGROUND

1. Field of the Invention

The invention generally relates to systems and methods for planning and execution of display advertising campaigns. More particularly, the invention relates to a method and system for trafficking one-to-one display ad campaigns to be executed with efficiency.

2. Background Discussion

Data driven display advertising is on the rise. Advertisers, publishers, data providers and advertising exchanges are all providing greater levels of audience data, user intent data, demographic data and contextual data with the result that advertising experiences shown to users can be customized to an individual user based on the individual user's current context. Given the number of possible combinations of contexts, providing a customized display ad banner often results in creating thousands of static banner creative experiences, all of which it is not possible to execute on. The process of implementing such an online advertising campaign is time consuming, manually labor-intensive and therefore prone to errors in the set up and distribution processes, further exacerbating the problems associated with campaign launch, maintenance and troubleshooting.

### SUMMARY

A method and system for trafficking one-to-one display ad campaigns centers around a Dynamic Ad Server that generates an advertising creative experience dynamically by assembling different ad subcomponents on the fly, selecting subcomponents based on publisher, user or media parameters submitted to the Ad Server at the time an ad impression is to be served. A business rules engine allows a marketer to author natural-language business rules. Using such system, campaigns can be designed and implemented wherein association of placements to creative tags is reduced to only a single tag per size per campaign for the entire media plan. By accommodating the rules to each ad placement dynamically, a marketer's intent can be fully satisfied. Time required for set-up and launch is dramatically reduced and maintenance and optimization is scalable.

### BRIEF DESCRIPTION OF THE DRAWINGS

FIG. 1 provides a diagram of a machine in the exemplary form of a computer system within which a set of instructions, for causing the machine to perform any one of the methodologies discussed herein below, may be executed;

FIG. 2 provides a diagram of a typical workflow involved in online ad campaign planning and execution;

FIG. 3 provides a matrix of variables encountered for personalized ad experiences;

FIG. 4 provides a high-level schematic diagram of an ad serving platform;

FIG. 5 provides a detailed sub-system diagram of an ad serving platform as in FIG. 4;

FIG. 6 provides a diagram of media partners, ad server and ad creative relationships;

FIG. 7 provides a diagram of a process flow associated with trafficking and parameter passing;

FIG. 8 provides a diagram of mechanisms associated with passing parameters from sources of traffic into the ad serving platform;

FIG. 9 illustrates different user experiences that feature in introductory and final end-frame animation sequences with display ad creative;

FIG. 10 illustrates different data feed and optimization-driven product placement and merchandising end frames;

FIG. 11 illustrates the different elements involved in the creative sub-components of an exemplar ad experience;

FIG. 12 illustrates base-level and creative attributes in a listings platform scheme;

FIG. 13 illustrates geographic, category-specific and custom attributes in a listings platform scheme; and

FIGS. 14a-14b illustrates a messaging grid schema.

### DETAILED DESCRIPTION

A method and system for trafficking one-to-one display ad campaigns centers around a Dynamic Ad Server that generates an advertising creative experience dynamically by assembling different ad subcomponents on the fly, selecting subcomponents based on publisher, user or media parameters submitted to the Ad Server at the time an ad impression is to be served. A business rules engine, allows a marketer to author natural-language business rules. Using such system, campaigns can be designed and implemented wherein association of placements to creative tags is reduced to only a single tag per size per campaign for the entire media plan. By accommodating the rules to each ad placement dynamically, a marketer's intent can be fully satisfied. Time required for set-up and launch is dramatically reduced and maintenance and optimization is scalable.

### GLOSSARY OF TERMS

Ad tag: An ad tag is a snippet of computer code, usually written in HTML (Hypertext Markup Language), that advertisers/agencies give to web publishers that run their advertisements. When a user comes to a web page and the ad tag is invoked, the user's browser requests the advertiser's server to retrieve the body of the advertisement—which is the creative associated with that page or placement.
Branding: The blend of art and science that manages associations between a brand and memories in the mind of the brand's audience. It involves focusing resources on selected tangible and intangible attributes to differentiate the brand in an attractive, meaningful and compelling way for the targeted audience. As such, a brand is a combination of attributes, communicated through a name, or a symbol, that influences a thought process in the mind of an audience and creates value.
Campaign: The process of planning, creating, buying and tracking advertising project from start to finish.
Creative: Ad banners and other forms of created advertising are generally referred to as “the creative”. Various technologies are used to develop the various types of creative. Common creative types include GIF, JPEG, Java, HTML, Flash or streaming audio/video.
Media Plan: A list of publisher sites, online advertising networks and online ad exchanges where a campaign shall go live.
Placement: A line item in a media plan. A placement can be a static advertising location on a publisher site, for example, a rectangular advertising unit on a site such as sports. yahoo.com, or it can describe that audience that the campaign is trying to reach.
Return on investment (ROI): ROI=Revenue generated from an ad campaign/Cost of the Media;

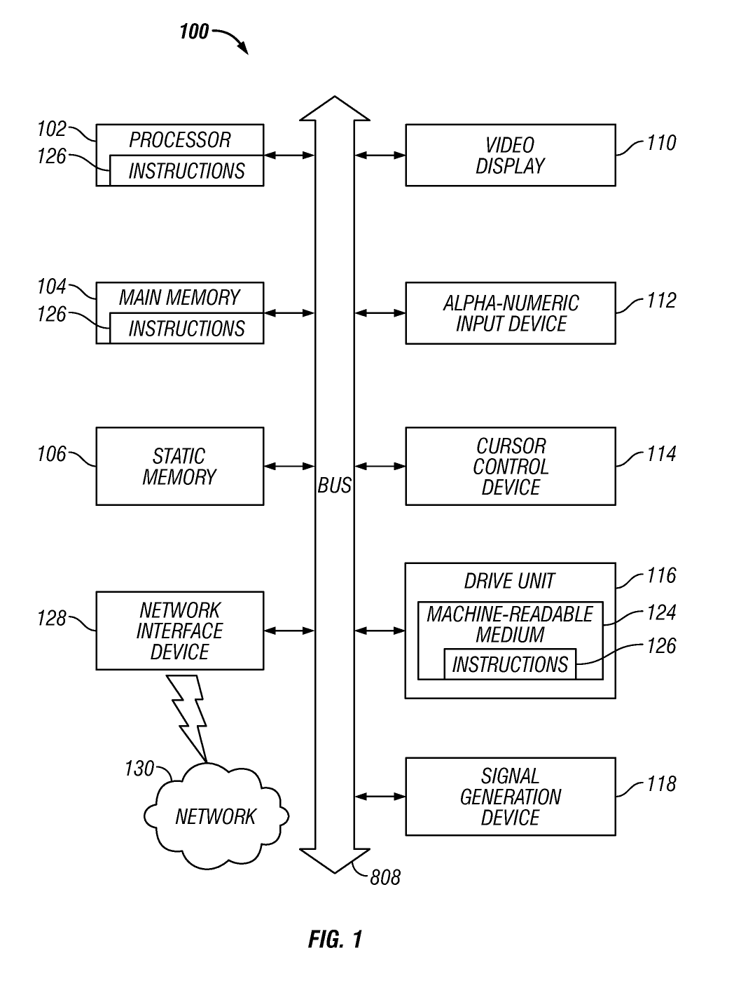

Referring now to FIG. 1, shown is a diagrammatic representation of a machine in the exemplary form of a computer system 100 within which a set of instructions for causing the machine to perform any one of the methodologies discussed herein below may be executed. In alternative embodiments, the machine may comprise a network router, a network switch, a network bridge, personal digital assistant (PDA), a cellular telephone, a web appliance or any machine capable of executing a sequence of instructions that specify actions to be taken by that machine.

The computer system 100 includes a processor 102, a main memory 104 and a static memory 106, which communicate with each other via a bus 108. The computer system 100 may further include a display unit 110, for example, a liquid crystal display (LCD) or a cathode ray tube (CRT). The computer system 100 also includes an alphanumeric input device 112, for example, a keyboard; a cursor control device 114, for example, a mouse; a disk drive unit 116, a signal generation device 118, for example, a speaker, and a network interface device 128.

The disk drive unit 116 includes a machine-readable medium 124 on which is stored a set of executable instructions, i.e. software, 126 embodying any one, or all, of the methodologies described herein below. The software 126 is also shown to reside, completely or at least partially, within the main memory 104 and/or within the processor 102. The software 126 may further be transmitted or received over a network 130 by means of a network interface device 128.

In contrast to the system 100 discussed above, a different embodiment of the invention uses logic circuitry instead of computer-executed instructions to implement processing offers. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large scale integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments of this invention may be used as or to support software programs executed upon some form of processing core (such as the Central Processing Unit of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

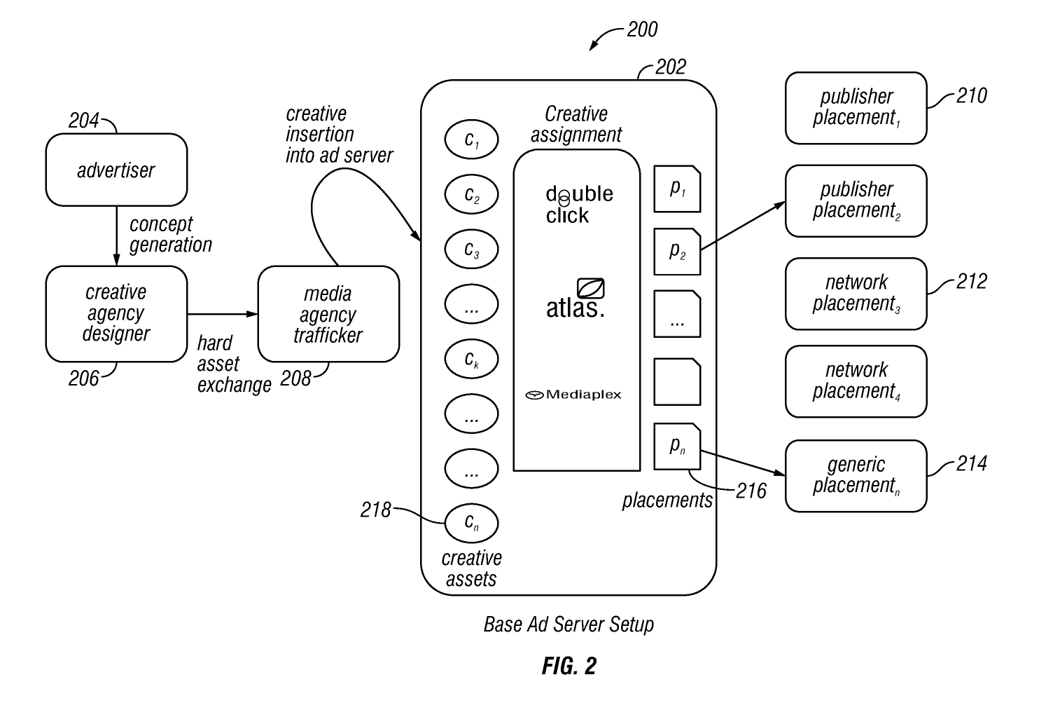

In the world of digital marketing, planning and execution of an advertising campaign usually involves collaboration between the advertiser, a creative agency and a media agency. An advertiser may have any of several motives for planning and implementing a campaign—increasing sales, generating leads, promoting a new product/service or strengthening the advertiser's brand identity. As in FIG. 2, the creative agency 206, working closely with advertiser 204, develops the campaign concept guided by the advertiser's 204 goals for the campaign. The creative concept blends attributes of the advertiser's branding guidelines and the targeted audience that the campaign is attempting to reach and the benefits of the product or service that is being promoted, along with products, messages and offers that are deemed to attract the intended audience to take action on the marketing campaign.

Often the campaign goals are defined in terms of ROI (return on investment) or brand engagement metrics. The campaign often also has goal to reach a certain number of unique consumers that fit the intended audience profile. Planning a campaign often involves selecting a theme for the campaign, for example, “ID theft” for an identity protection service, or “Live Richly”, promoting the use of a credit card, and so on.

The media agency 208 is enlisted to translate the campaign goals into “media selection” and “media purchase” activities. In online marketing that employs display advertising, media selection and media purchase involve performing research on where the intended audiences can be reached and issuing Requests for Proposal (RFPs) to publishers 210-214 that have traffic. Negotiation ensues between the media agency and the publisher/ad network/ad exchange's 210-214 sales team for the right price to pay for such traffic. At the end of the RFP response process, the media agency 208 typically arrives at a Media Plan, which is an itemized list of publisher sites, online advertising networks and online ad exchanges where the campaign will go live. These line items on a media plan are referred to as “placements”.

A placement can be a static advertising location (like a billboard) on a publisher site such as a rectangular advertising unit on sports.yahoo.com or a sidebar-advertising banner on cnet.com reviews section. Alternatively, a placement can also describe the audience that the campaign is attempting to reach—for example, a placement may be all 18-35 year old women that are known to be enthusiasts for high fashion apparel. Regardless of how a placement is described, a placement carries with it an advertisement size (referring to the creative rendition of the concept in a rectangular or leaderboard or skyscraper form factor) as well as some attributes such as the URL of the site, user characteristics and so on.

The next step in campaign execution is to assign creative experiences to placements. For example, the advertiser and creative agency might conceive of a blue background with male oriented messaging for a sports.yahoo.com placement, or a softer pastel colored advertising creative milieu with products and services aimed at women on an advertising.com placement. In today's digital marketing landscape, the task of generating creative experiences is handled by the creative agency and advertiser. The media agency personnel 208 receive a set of creative ad banners from the creative agency 206 and are provided instructions on how to show the ads to the appropriate audiences. This media to creative coordination is handled by a media agency 208 by assigning one or more creative banners to each placement.

Thus, the media agency 208 finalizes a media plan, arrives at the placements, receives creative ad banners from the creative agency 206, assigns creative banners to placements and completes the campaign set-up process.

The next phase in campaign execution typically involves generating “ad tags” for distribution to each publisher and providing instructions to the publisher to set the ad tag in rotation starting with the launch date and time for the campaign. When the ad tag code is invoked by a user's browser, the call for a creative comes into the ad server 202 and the appropriate look up resolution occurs between the placement 216 and the creative 218 that the placement is mapped to, and a creative ad banner is returned to the user's browser for rendering.

### The Problem:

Current methods of executing such campaigns involve one or more of the following actions:
Generation of 100s or 1,000s of distinct hard creative assets to accommodate any form of creative messaging;
Insertion or trafficking of each of the creative assets into a base ad server platform such as ATLAS (MICROSOFT CORP., Redmond, Wash.), DOUBLECLICK (GOOGLE INC., Mountain View, Calif.) or MEDIAPLEX (VALUECLICK, INC., Westlake Village, Calif.);
Each publisher placement requires its own separate entity to be created in the base ad server;
An advertiser's purchase price for each placement may be different, and hence for reporting and computing the return-on-marketing spend for a given campaign, agency personnel are required to create an object for each placement in the base ad server;
There is an association of specific creative or creative variations to each placement in the media plan. For example, if a marketer asks for testing two different headline messages to a placement, which is targeted to a male population, then both of those distinct hard creative assets need to be associated with that placement; and
Ad tags have to be generated for each placement, to be distributed to each of the publishers.

Each of the above steps is time consuming, manually labor intensive and hence prone to errors in the set up and distribution processes, which exacerbates the problems associated with campaign launch, monitoring and troubleshooting. Additionally, the conventional trafficking process is not scalable. The following use case illustrates with an example why this process of placement to hard creative association is manual, laborious, time intensive and prone to frequent errors (the following is from an actual campaign that was run as per the advertiser requests):

Consider the following use case delineating the campaign request:
3 different headlines for each gender;
4 product sets of 20 each for each of the 50 states in the United States, that need to be featured in the campaign;
3 overall advertising user interface concepts that are to be experimented with;
2 call to action messages for each of the different experiences; and
3 ad sizes for this campaign.
   The total numbers of hard creative assets (in this instance, Adobe Flash banners) that need to be produced for this campaign execution are:
3×2 genders×4×50 states×3 concepts×2 call to action messages×3 sizes=21,600 Flash creative files.
   Also, business rules that associate creative files with each placement for specific audience or media parameters must be considered. This needs to be performed carefully by aligning with the needs of the media plan. So, finding a file from the list of 21,600 and associating it with one or more media placements is not automatic, or business rule driven within the current crop of leading base ad servers. For a campaign of this size, this results in a team consisting of 2 traffickers working for 2 full days to accomplish this trafficking process. Also, any changes to the media plan or variations in the creative experience require re-trafficking most, if not all, of the entities in the system.

Scalability issues that arise on the Internet, when attempting to do one-to-one marketing, are onerous and cannot be manually handled. The underlying ad serving platforms aggravate the problem of trafficking and campaign management by sticking to an ad server technology that is a static application requiring human beings to associate creative files to placements in this manner.

A solution to the above problem involves the conception and execution of a Dynamic Ad Server, whose functionality consists of dynamically generating an advertising creative experience, which:
a) Constructs an ad experience dynamically by assembling different subcomponents of an ad on the fly;
b) Selects the subcomponents that need to be assembled based on publisher, user or media parameters that are submitted to the ad server, at the time an ad impression is to be served;
c) Uses a business rules engine within the ad server to author the higher-level marketing rules, as opposed to translating them into technical file and object level associations;
   a. Within this Dynamic Ad Server, a marketer authors natural-language rules, such as:
      i. For Males rotate through Headline 1, Headline 2 and Headline 3;
      ii. Filter product content based on user's geographic state location, where product data has already been submitted to the dynamic ad engine as a feed;
      iii. All other creative variants are booked into the system as creative variants to be targeted and optimized to.
         The actual campaign execution from a media agency trafficker side, involves, for example, the following steps:
Create data and asset feeds and submit to the an ad delivery platform such as TUMRI (TUMRI, Inc., San Mateo, Calif.);
Author marketing rules and submit to the ad delivery platform;
Get a single ad tag per size per campaign from the ad delivery platform;
Set up 3, for example, Dynamic Ad Server ad tags (one per size) as smart creative tags in the base ad server, instead of trafficking 21,600 creative assets (c₁ to cₙ); Set up only one placement per distinct site in the media plan; and
Association of placements to creative tags is only one per size per campaign.
   By following the above steps
The intent of the marketer is fully satisfied in terms of accommodating the business rules via dynamic ad construction
The time taken to set up a campaign and launch is dramatically reduced, following with examples is important

The process of campaign launch, maintenance and optimization is now infinitely scalable.

### Ad Tag Structure:

In an embodiment, PARAMETER_NAME is the variable name provided by the ad delivery system and Variable_Value is the publisher/network/advertiser/agency-specified value in the tag syntax shown in Table 1, below. Each ad tag may be customized to the media source on which it runs.

TABLE 1

<script type=“text/javascript”
src=“http://www.tumri.net/ads/mts/5667?
CLICK_TRACKER= | | Publisher side click tracker | | &
THIRD_PARTY_IMPRESSION_BEACON= | | 3^{rd} party Impression
Beacon | | &
THIRD_PARTY_CLICK_BEACON= | | 3^{rd} party click Beacon | | &
CONTEXTUAL_KEYWORDS=Comma separated keyword list&
PLACEMENT_ID=Publisher Placement Id&
USER_POSTAL_CODE=User Zip Code&
USER_GENDER=User Gender&
USER_AGE=User Age&
CONTEXTUAL_CATEGORY=Contextual Category&
USER_AUDIENCE_SEGMENTS=Comma separated audience
segments&
CUSTOM_PARAMETER_1=Custom parameter”>
</script>

### Description of the Variables Encountered for Personalized Ad Experiences

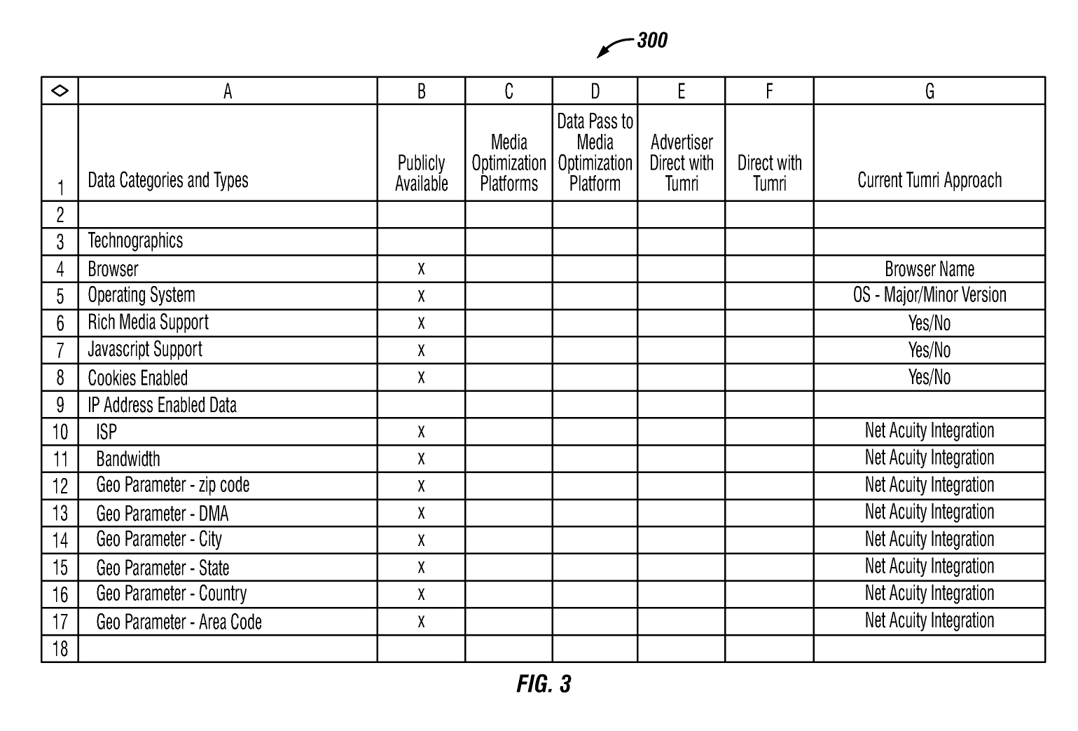

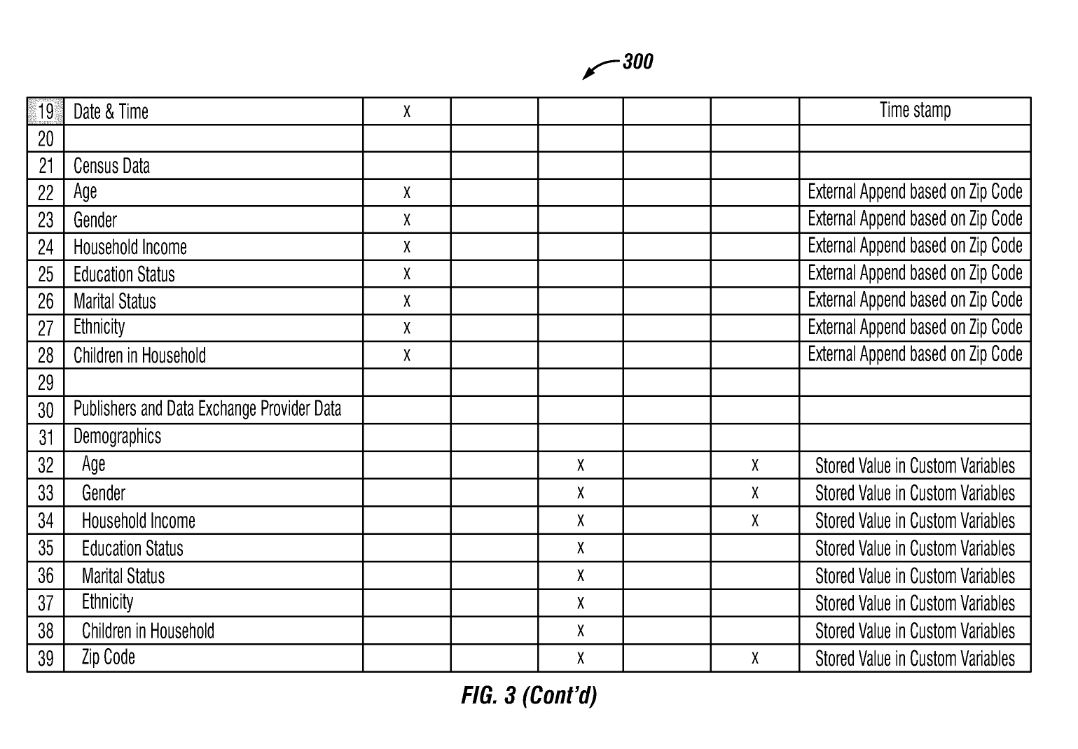

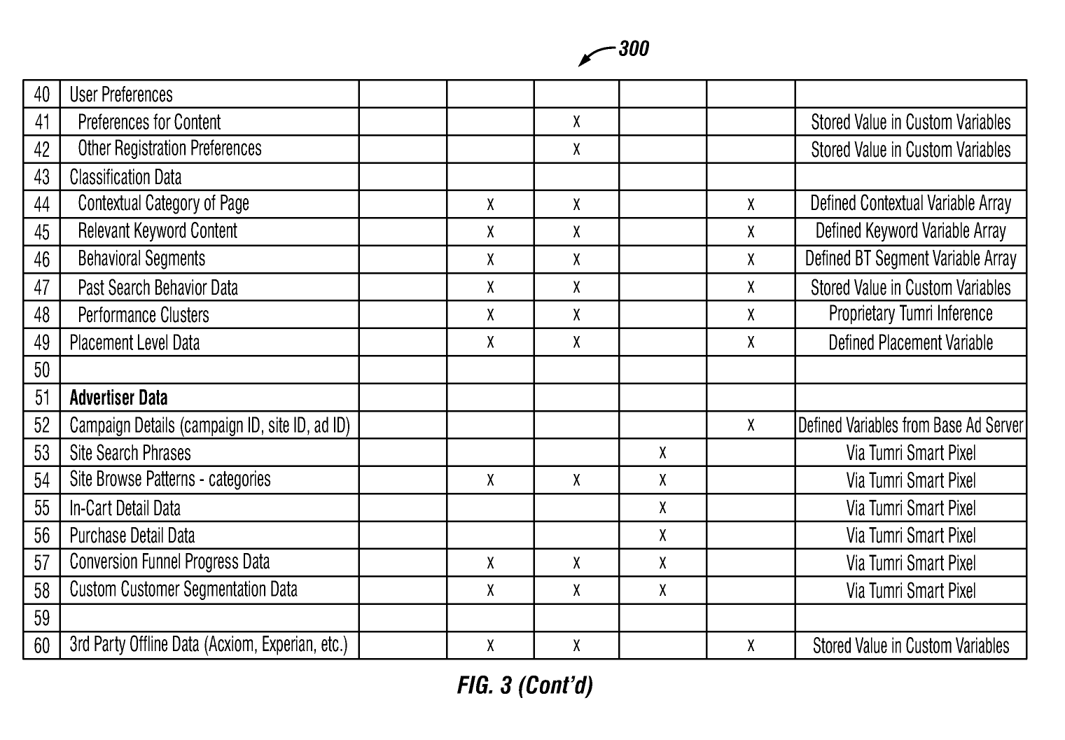

FIG. 3 shows a matrix 300 of at least some of the variables encountered for personalized ad experiences.

### Detailed Solution Architecture and Process Description:

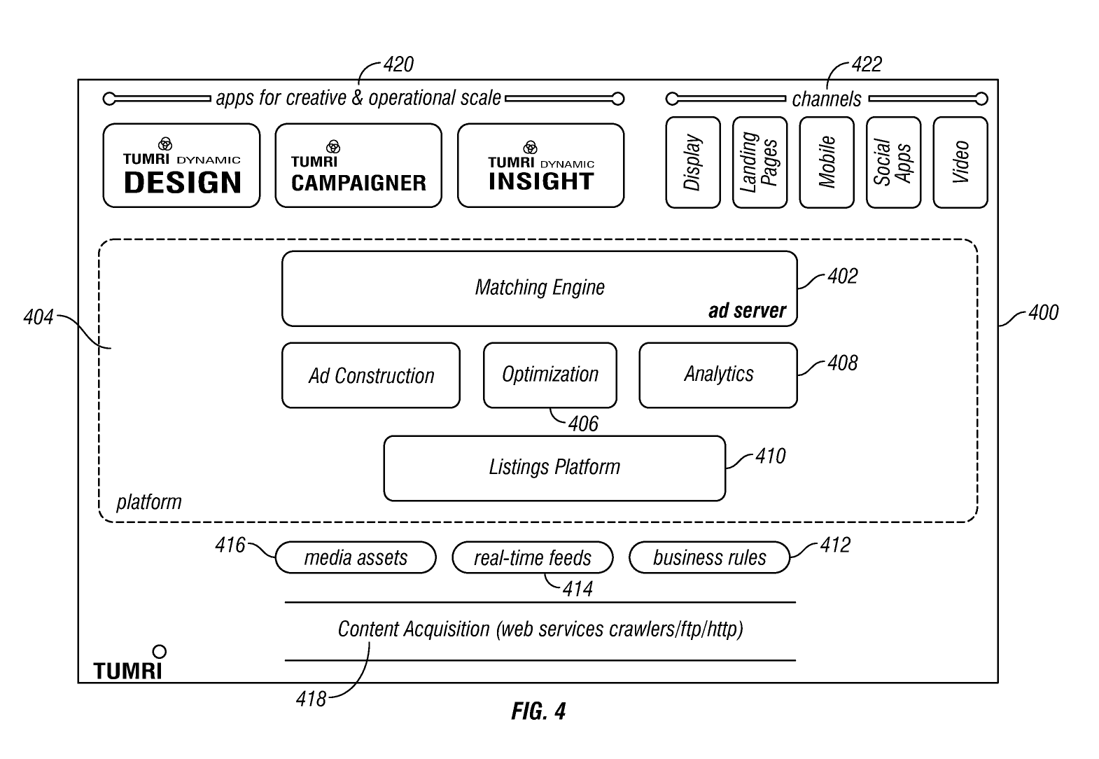

FIG. 4 provides a high-level schematic diagram of a dynamic ad serving platform 400 comprising one or more of the following components. This platform consists of:
Content Acquisition 418: A system for acquiring content into the serving environment. The content acquisition system accesses content using Internet protocols of HTTP, FTP and Web Services. Content can also be submitted to the system on a file system that is accessible to the content acquisition system, which is then assimilated using standard file system access methodologies. A dynamic ad serving platform requires content of the following types for ad construction:
   Business Rules 412
      Examples of business rules are—for ads running yahoo.com, serve only apparel products; to men serve men's jerseys, to audiences from CA and NY show only new Smart Phones with specific promotional pricing et al;
   Real-time Feed 414
      Examples of real-time data feeds: the entire product catalog that is refreshed every 15 minutes from a large online retailer, travel prices and offers that change every 10 minutes for an airline/travel provider, job listings from a large online job site, real estate listings, people profiles from a dating site etc.;
   Media assets 416
      Background images, brand logos, messaging snippets, videos, font files, Flash creative concepts, video creative snippets, assets that make up ad experiences etc. form examples of media assets that construct a display advertisement online
Real-time ad construction engine consists of the following functional modules:
   At least one Matching engine module (402) which is also an ad server
      Matching engine functions to accept incoming media and audience parameters, applies business rules and selects listings and creative sub-components that form the elements of the ad experience.
   At least one Ad Construction module (404)
      Ad Construction module assembles the ad experience on the fly and lays them out for rendering on the user's web browser to conform to the campaign specifications.
   At least one Optimization module (404)
      If there are multiple candidate creative sub-components and listings, then the optimization selects the set of components that are likely to produce the greatest performance for given ad campaign. It works in concert with the Analytics module (408) to arrive at the best components.
   At least one Analytics module (408)
      As the campaign runs and serves ad impressions, the analytics module continuously computes the relative performance each subcomponent and provides data to the Matching engine and the Optimization module to achieve performance improvements. The data aggregations that are produced from the Analytics module also give visibility to the advertiser, the media agency and creative agency into the workings of the campaign.
   At least one Listings Platform module (410)
      The listings platform prepares the content acquired form the Content Acquisition system for dynamic ad serving by injecting this data into the real-time matching engine module.
Applications that enable scalable operation of the dynamic ad serving platform
   Applications for creative and operation scale 420, including;
      Dynamic Design
         Dynamic design is an application extension to Adobe Flash that aids creative designers and developers to build dynamic advertising templates for ad construction.
      Campaigner
         Is web-enabled software that allows media and creative agencies to author the business rules that govern the campaigns. It also allows the constituents to create the One Tag per size that eventually get trafficked into the base ad server platform.
      Dynamic Insight
         Is a web enabled software portal that allows for the visualization of data that is produced from the Analytics module, described above.
The dynamic ad serving platform is capable of distributing the constructed advertisements into different channels of distribution 422, including:
   display—banner advertising across the Internet;
   social—social network sites and the types of advertising that are supported by them that are different from standard banner display ads;
   mobile—advertising to be shown to mobile phone users as they browse the web on Smart Phones;
   Video: advertising that accompanies online videos as in pre-roll, mid-roll and post-roll video placements.

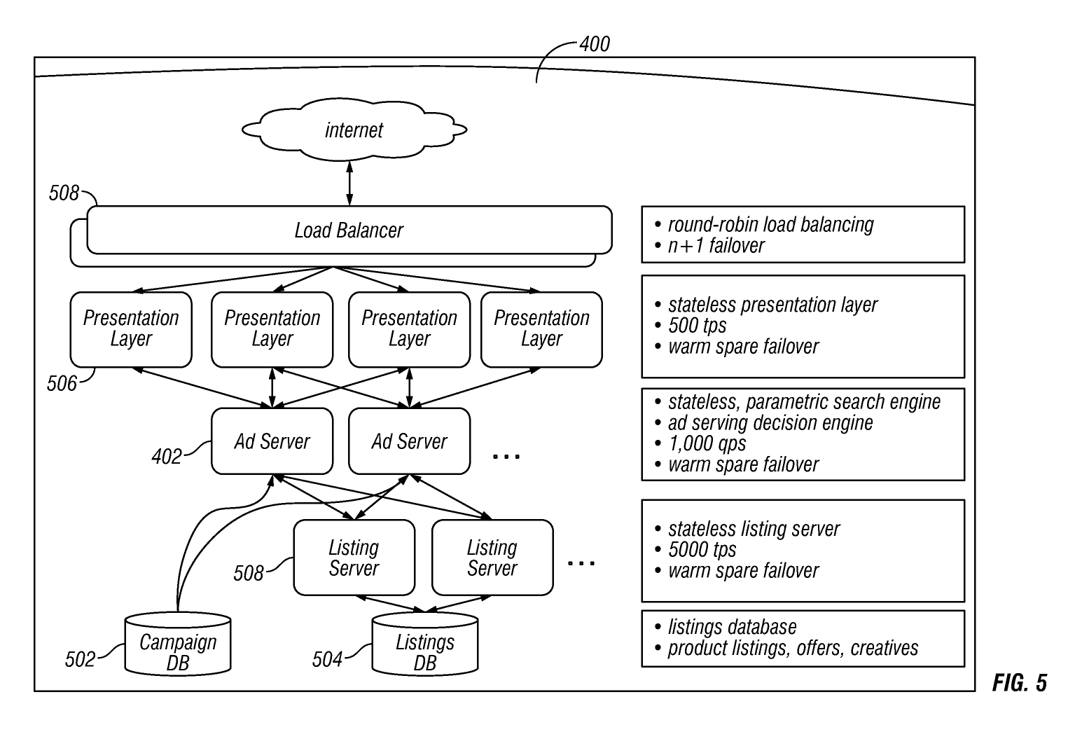

Turning now to FIG. 5, shown is a detailed sub-system diagram of the ad serving platform shown in FIG. 4. The ad serving platform 400 further includes at least one of the following sub-systems:
At least one load-balancing module 508;
   The load balancer shunts load coming from ad impression requests to one of many ad servers in a cluster of parallel ad serving computers.
   Load balancing strategies may be numerous. But in this embodiment, we simply pick the next computer in sequence to serve the request;
   n+1 failover 518—in the industry standard terminology that designates one additional machine in a cluster of n machines for dealing with the failure of one of the machines in the cluster. The cluster of machines is auto balancing in that, if a failure occurs the spare machine, the (n+1)^{th} machine is automatically introduced into the cluster to deal with failed computer;
   Load balancer passes the request to the Presentation Layer
Presentation layer 506;
   Presentation layer is the software embodiment of the Ad Construction module described above
   The presentation layer server is a stateless compute server that can process any incoming request without any preservation of state from one request to another;
   Rated capacity of this presentation layer is 500 transactions/second (TPS) for a typical machine in this cluster with dual core single U computer with 2 GB RAM and 100 GB disk space;
   Warm spare failover machines provide for the n+1 failover mechanism in the cluster;
   Presentation layer logs the ad request and passed the request down to the ad server for the subcomponents to be selected for presentation purposes.
At least one ad server 402;
   Ad server receives the request from the presentation layer.
   The ad server here is a software embodiment of the Matching Engine described above
   The ad server contains a stateless parametric search engine, which serves to match incoming ad impression requests that carry data with it to the creative components and listings that form an experience. The ad server talks to the listings server to retrieve content associated with the given match;
   The ad serving decision engine is a combination entity that leverages the optimization module informed by the analytics module;
   Performance rating of this server has been clocked at 1000 queries/second (QPS) per machine in the cluster with a typical machine configuration possessing 4 GB RAM, dual CPU dual core Intel processors and 200 GB disk space to support the capacity;
At least one listing server 500;
   Listings server is a high performance, stateless listing lookup server that serves to retrieve content from its repository for content that is appropriate for a given advertiser campaign;
   This look up server performs at 5000 TPS with a typical machine configuration consisting of dual CPU dual core Intel processors, 16 GB RAM and 2 TB of disk space to accommodate the data processing volume;
   A warm spare is provided for n+1 failover;
   The listing server talks to the listing database for content retrieval; Listing server requires a listings database to function in concert;
At least one listings database 504;
   The listings database is an in-memory database that stores all the content that has been acquired from the Content Acquisition system described above;
At least one campaign database 502;
   Forms the persistent store for campaign business rules and the logical associations of creative assets, placements and listings.

### Workflow in Trafficking:

### High-Level Architecture

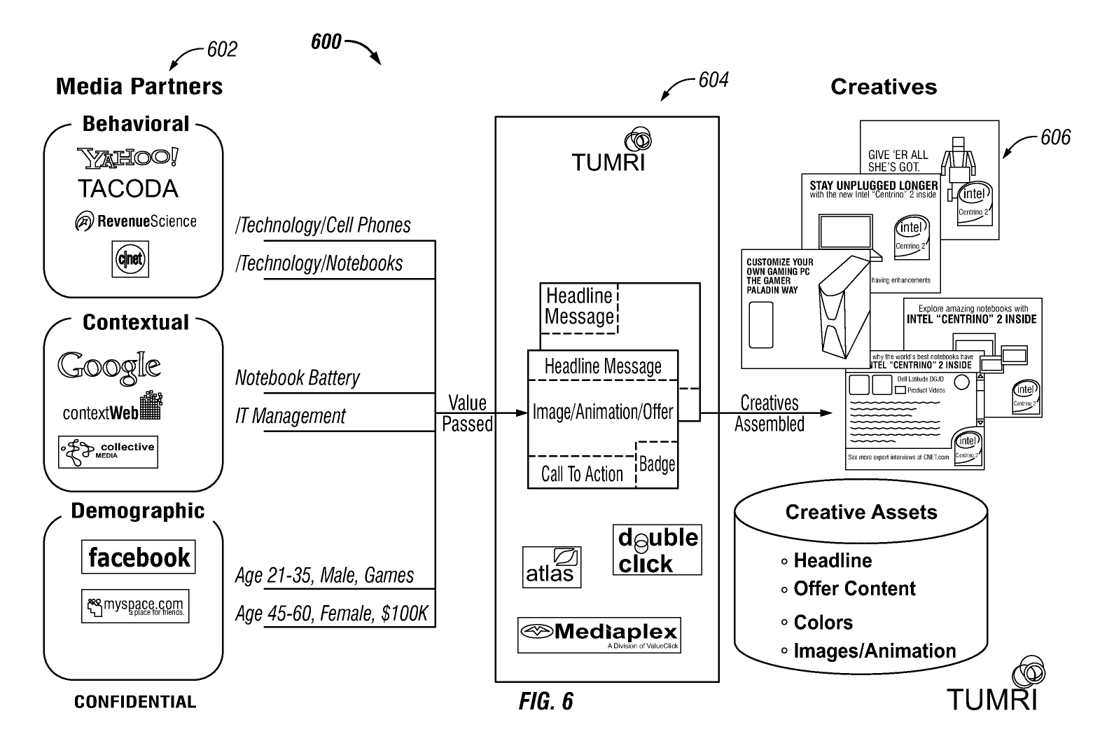

FIG. 6 shows a flow diagram 600 depicting media/data partners, the base ad server and ad creative relationships.
In this diagram the flow of data is described at a high level with illustrative media partners with an example of a dynamic Intel campaign execution.
Media Partner Example 1 (Behavioral): These media partners provide behavioral data associated with a user at the time an ad impression is to be served to the user. In this example, we are pictorially showing that the providers: Yahoo!, CNET, Revenue Science and Tacoda are passing data signifying the user's behavioral interest in “/Technology/Cell Phones” and “/Technology/Notebooks” to the Tumri dynamic ad serving platform for dynamic ad construction and optimization.
Media Partner Example 2 (Contextual): These media partners provide contextual data associated with the page on which an ad impression is about to be served. In this example, we are pictorially showing that the providers: Google, Context Web and Collective are passing data signifying that the page the user is reading currently is related to “Notebook battery” and “IT Management”, and this measure of intent and contextual relevance is sent to the Tumri dynamic ad serving platform via the base ad serving platforms of DoubleClick, Atlas or MediaPlex for dynamic ad construction and optimization.
Media Partner Example 3 (Demographic): These media partners provide demographic data associated with the user to whom an ad impression is about to be served. Demographic data can be age, gender, educational qualifications, marital status, children in the household and optionally some aspects of their interests. In this example, we are pictorially showing that the providers: Facebook and My Space are passing the values of “Age 21-35, Males and Games” and “Age 45-60, Female, $100K household income” that the user belongs to and this data is sent to the Tumri dynamic ad serving platform via the base ad serving platforms of DoubleClick, Atlas or MediaPlex for dynamic ad construction and optimization.
The Tumri ad serving platform 604 is depicted in the middle to show the integrated existence of the Tumri platform with the base ad serving platforms of DoubleClick, Atlas and MediaPlex.
   Creative assets 606 show the different rich media, advertising templates, headlines and marketing collateral that formulate the ad experiences.

### Trafficking Options

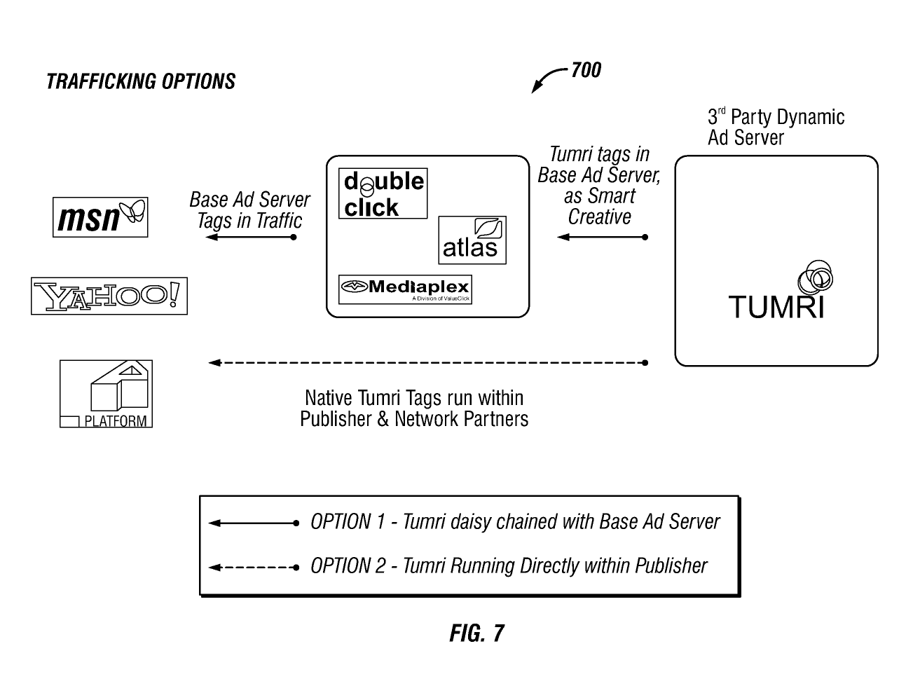

FIG. 7 provides a diagram of a process flow 700 associated with trafficking and parameter passing
There exist 2 options to enable a dynamic creative campaign to achieve the benefits of the described invention. In both options the one tag per campaign per size are authored and retrieved from the Tumri system. The two options are described below:
Option 1: In this option, the Tumri tags are embedded into the base ad server platforms like DoubleClick or Atlas or MediaPlex. The placement tags are generated from the base ad server platforms and handed over to publisher for final trafficking to web browser to their respective properties.
Option 2: Since the Tumri dynamic ad serving platform is also an ad server, the Tumri tags may be submitted directly to the publishers for trafficking.
The selection of Option 1 or Option 2 depends on the specific business use case being adopted by the media agency. Both are viable options for enabling campaign executions, and are functionally equivalent.

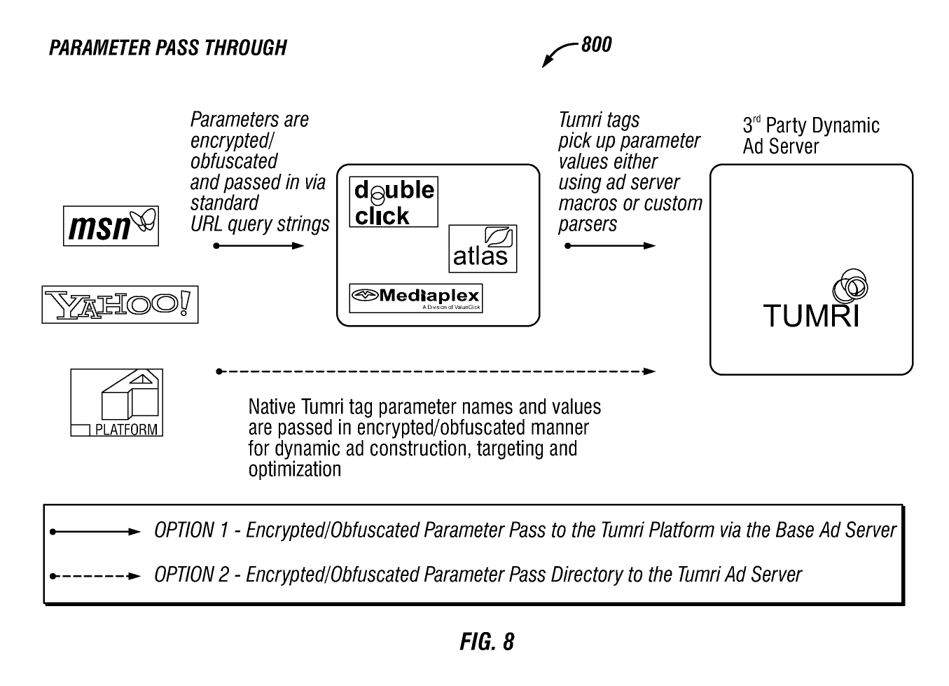

FIG. 8 provides a diagram of mechanisms associated with passing parameters from the sources of traffic—publishers or network partners into the Tumri dynamic ad serving platform for targeting, optimization and ad construction based on targeting rules.

In this diagram the mechanism for data passage is being depicted taking into account Options 1 and 2 of the trafficking model described in the previous sections.

### Data Passing in the Two Options Above:

1. Option 1: In this option, the publishers and networks append data values for a given user or ad impression as key-value pairs appended at the end of the base ad server ad tag for indirect assimilation by the Tumri dynamic ad serving platform.
2. Option 2: In this option, where the Tumri ad tag is being served directly by the publisher in question, the data is passed directly into the Tumri ad tag which is then used for ad construction and optimization.

### Illustration of the Use of the Ad Serving Platform Via a Customer Case Study:

The following case study illustrates a highly brand conscious, performance-driven advertiser, who leverages the ad serving platform for dynamic ad executions. Using the content and listings platforms, as shown in FIGS. 4 and 5, the advertiser generates tens of thousands of distinct ad experiences for one-to-one marketing scale and also leverages the targeting and optimization engine to generate great performance lift and optimization across the media landscape. The ad serving platform, working with Agency.com, has contributed to the advertiser establishing highly relevant, dynamic, real-time display ad experiences and has been successful in optimizing display advertising to be the highest performing online marketing channel for Nike.

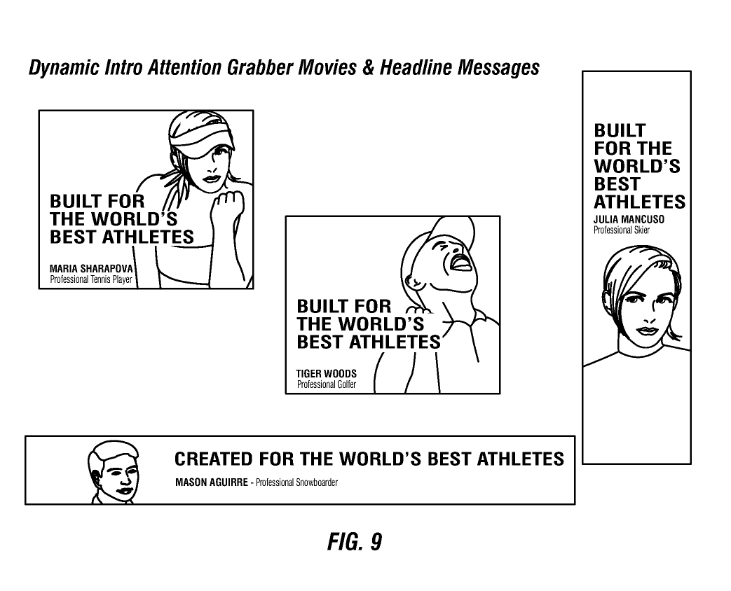

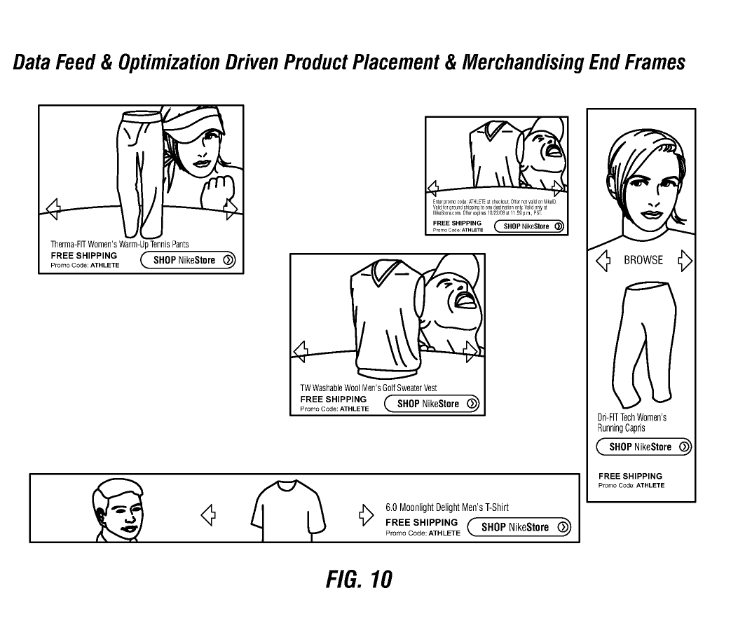

FIGS. 9 and 10 illustrate exemplary user experiences featuring introductory and end-frame animation sequences. In particular, FIG. 9 depicts dynamic introduction attention-grabbing movies and headline messages. FIG. 10 depicts data feed and optimization-driven product placement and merchandising end frames.

Salient Features of these Executions:
The exemplar creative design was devised by a creative development agency, working with the advertiser's brand marketing team.
The exemplar creative design incorporates
   10 different athletes that are featured in the ads, each a distinct spokesperson for the advertiser. The athletes hail from a variety of sports such as tennis, golf, running, skiing and soccer;
   Each athlete driven creative experience includes 3 different attention grabber intro movie experiences;
   Each athlete also is associated with 4 different headline messages to be varied;
   For each athlete, there are sets of 50 products to be featured in the ads for merchandising that are relevant to the sport;
   Each product may have an online coupon associated with it for redemption on the Nike web site. The coupon codes are distributed for user exploration within the display ad;
   Product data feed—in terms of pricing and availability—changes at least once every day to be automatically fed into display advertising;
   There are 4 different Call to Action messages featured;
   There are 3 different creative treatments for the background and call to action messaging within the ad unit;
Media to Creative association
   The media plan consisted of 125 different placements across the top portals, networks and individual publishers with distinct rules for targeted ad experiences, with the following illustrative examples of the rules of engagement:
      Sports.yahoo.com shall receive only Tennis and Golf experiences
      Facebook demographic targeting involves Gender and Education Level with associations of athletes and product prices within each ad rendered;
   Enhanced retargeting executions on several lines and on Run of Network, using Tumri remarketing pixels;
      Leverage onsite behavior on advertiser's web site and feature ad experiences bound to user actions on the site in terms of products and categories browsed, shopping cart activities etc.
   Media and creative optimization was bound to a strict ROI metric to segment audiences across many variables, and progressively serve more optimal content experiences to achieve the goals of the campaign.

### Content and Creative Schemas and Asset Exchange Mechanism

As a general rule, the Listings Platform can ingest content in any format and transform it and load it into the ad delivery system. The following is a suggested schema for content and data protocol establishment for automatic upload and infusion into ads in a running campaign.

### Creative Element Schema Definition

### Process:

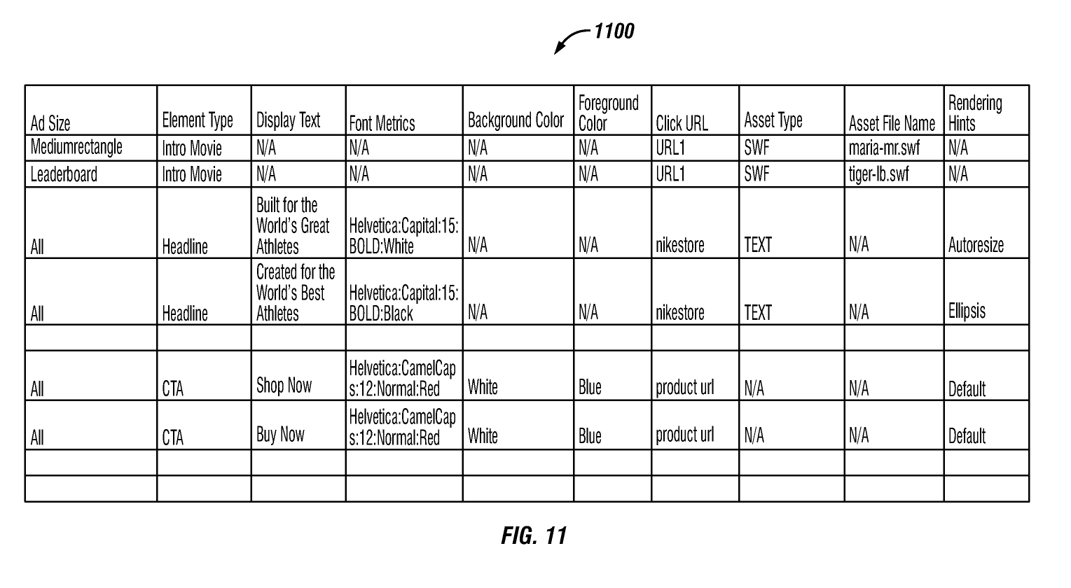

Identify the elements of the ad experience that are dynamically altered;
Fill out the attached spreadsheet for all different variants associated with each subcomponent of the ad;
Assemble all the hard assets like images and Flash movies required to populate the experience;
Creative content package=Spreadsheet metadata associated with the creative subcomponents+Assets, upload to a Tumri operations provided secure FTP site; and
The listings platform sends notification when the creative assets are processed and ready for staging+preview.
The data schema 1100 shown in FIG. 11 illustrates at least some of the different elements involved in the creative sub-components of the exemplar ad experience.

### Listings Data Feed Definition & Upload Semantics

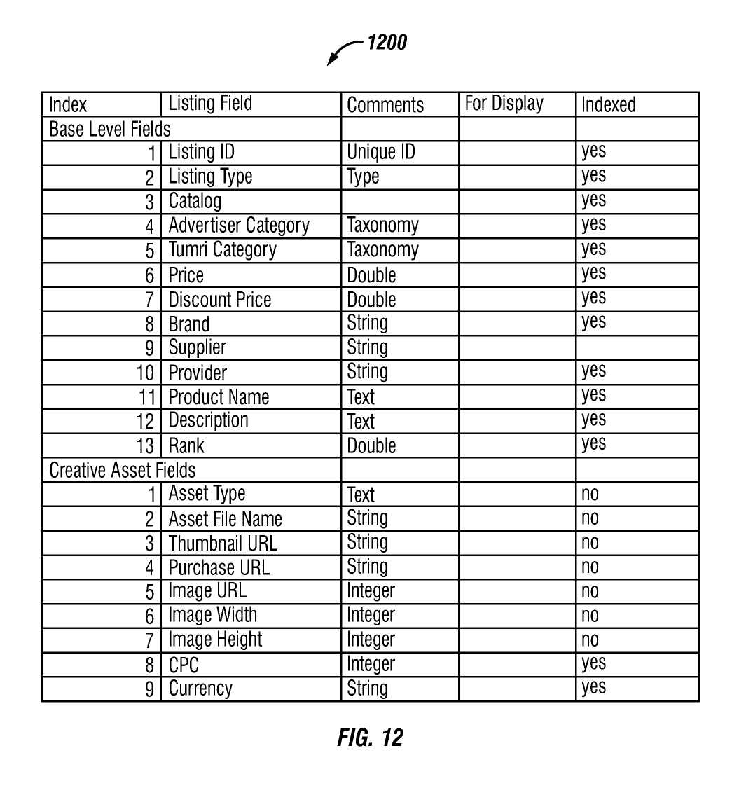

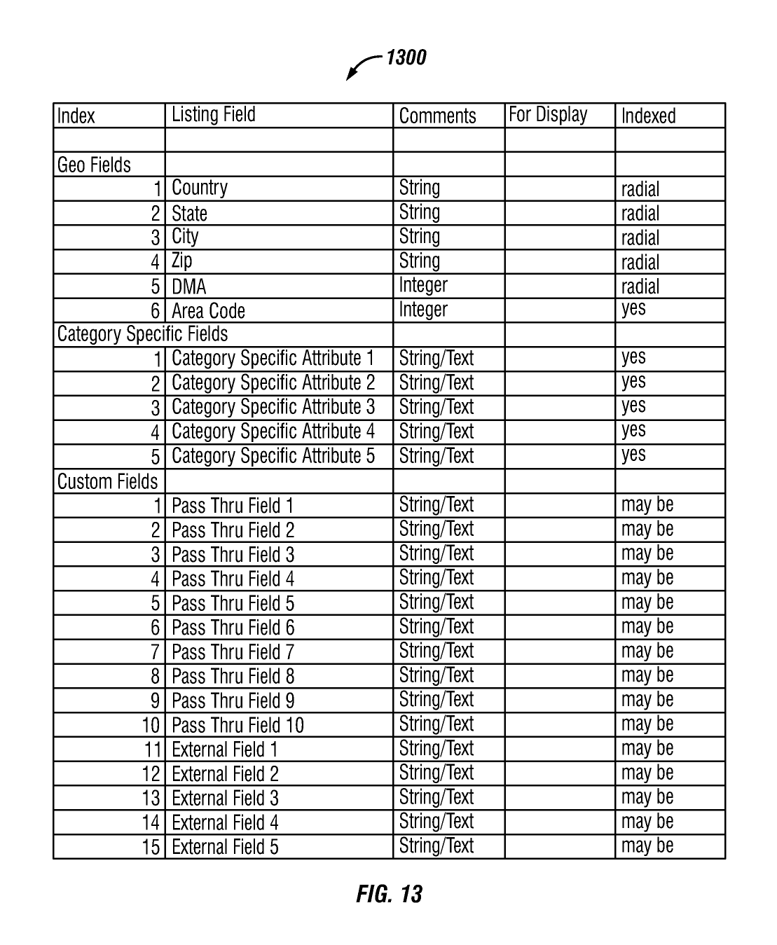

The listings platform 410 is built for scalability in terms of volume and pace of ingestion of listings in the form of data feeds. The following mechanisms exist for specifying the sources to get data forms:
Secure FTP server hosted by the advertiser/agency/ for the delivery of listings data feed;
Web service to retrieve semi-structured data in the form of XML to feature in the ad unit; and
RSS data feeds.
   Data Formats that are Supported in the Platform:
EXCEL (MICROSOFT CORP., Redmond, Wash.) files;
Flat file databases;
Proprietary data format (requires data specification);
XML (eXtensible Markup Language); and
SOAP (Simple Object Access Protocol) envelopes.
   Process for Uploading Data into the Ad Delivery System:
Specify data retrieval sources with credentials or authentication for retrieval;
Establish frequency of polling from source;
Submit test data to the ad operation for a one-time on-boarding sequence;
Specify notification and escalation methodology for errors/warnings in feed ingestion;
Specify properties of asset population e.g., whether to thumbnail images, whether to host images within the platform and so on;
Set up notification parties for content available for staging/preview;
Approve/Disapprove content to move from Staging to Production; and
   The tables 1200, 1300 shown in FIGS. 12 and 13, respectively, illustrate the internal schema used for loading listings data feeds into the system. FIG. 12 shows Base Level and Creative Attributes. FIG. 13 shows Geographic, category-specific and custom attributes in the listing platform scheme.

### Marrying Targeting & Creative Using a Message Grid

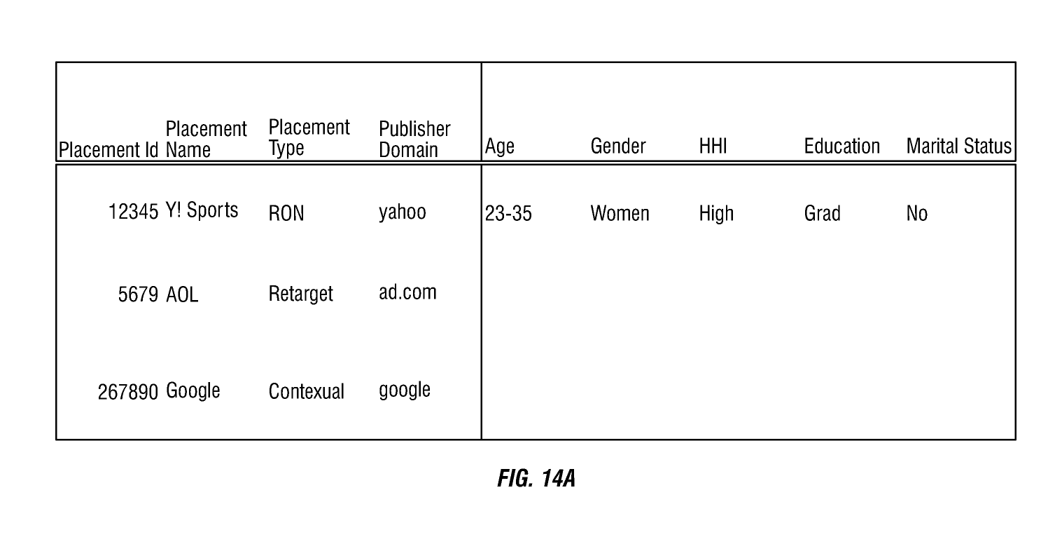

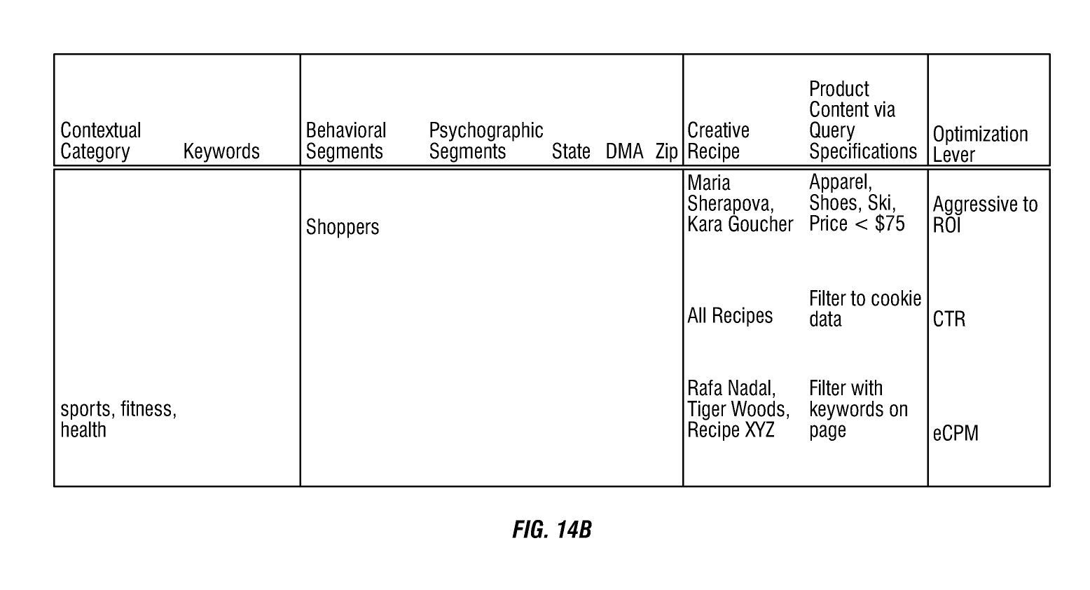

Once the raw contents of the ad experience are on-boarded and submitted for automatic processing, the creative and media executioners are ready to preview the ad creative assets as they would appear on the corresponding media plan.
The ad delivery server and optimization platform allows the unique ability to advertisers, media and creative agencies to incorporate targeting rules and optimization levers using a method called Messaging Grid.
A Messaging Grid brings the media and creative together in a simple, yet powerful way for authoring dynamic ad execution rule sets. The table in FIG. 14B illustrates the way such connections are established.

### Process for Enabling Message Grid:

For each media line, identify the targeting parameters for which a customized ad experience is wanted;
Targeting parameters may fall under Placement Level, Demographic, Behavioral, Contextual and Psychographic buckets;
Enumerate the creative recipes and corresponding products/listings to be served when serving to a specific “targeting media vector”;
All fields in the Message Grid are multi-valued. More than one value can be specified in each cell;
Upload the Message Grid to the same location as the creative assets;
Await the system notification of rule sets becoming ready for preview in staging;
Approve/Disapprove the targeting rules any number of times during the day; and
The system automatically applies these targeting rules and optimization levers to a running campaign without any re-trafficking or changes in media plan within the base ad servers.

As with the creative component assets, and listing data feed input into the system, users can simply author a new Messaging Grid and upload to the servers for instant application of the rules codified in the grid. Optimization levers control the metric to optimize against. If there is a placement for which no rule is specified, the engine automatically detects patterns of good performance and optimizes to such segments.

After the above content is set up, the tags that are generated are simply the One Tag that incorporates the marriage of media and creative using a single creative set up method.

### Broad Use Cases or Methods of Using the Ad Serving Platform:

One-to-one marketing, such as audience/publisher or advertiser campaign-specific;
Always-on campaigns can continue to run with the same ad experience tag year long, while the actual resultant ad experiences may be dramatically different from each other; and
With carefully constructed reusable template mechanisms, ad experiences can transcend product categories, brands, merchandising calendar executions and different ad styles.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A dynamic ad server comprising at least one computational device and a plurality of modules executing thereon, the modules comprising:
at least one module for constructing an ad experience dynamically by assembling subcomponents of an ad on the fly;
at least one module for selecting said subcomponents at the time an ad impression is to be served, based on at least one of: publisher, user and media parameters submitted to the ad server;
at least one business rules engine for processing natural-language marketing rules specifying said parameters; and
at least one module for designing and implementing a campaign wherein association of placements to creative tags is limited to a single tag per size per campaign for an entire media plan.

2. The dynamic ad server of claim 1, wherein processing said natural-language marketing rules comprises any of:
authoring said natural-language marketing rules by a marketer;
submitting a file containing said natural-language marketing rules to said dynamic ad server; and
processing said natural language marketing rules to dynamically generate ad experiences that satisfy intent of the marketer.

3. The dynamic ad server of claim 1, further comprising
a stateless parametric search engine, which serves to match an incoming ad impression request received from a presentation layer that carries data with it to the creative components and listings that form an experience, wherein said ad server communicates with a listings server to retrieve content associated with the given match.

4. The dynamic ad server of claim 1, further comprising a matching engine that performs any of the steps of
accepting incoming media and audience parameters,
applying business rules; and
selecting listings and creative sub-components that form the elements of the ad experience.

5. A dynamic ad serving platform comprising at least one computational device and at least one module executing thereon, the at least one module comprising at least one of:
a content acquisition module for acquiring content from outside the serving environment;
at least one ad server, the ad serving comprising a matching engine module for accepting incoming media and audience parameter, applying business rules and selecting listing and creative sub-components that form the elements of the ad experience;
at least one ad construction module for assembling ad experiences on-the-fly and laying them out to conform to campaign specifications for rendering on a user's web browser;
at least one optimization module for selecting a set of components likely to product best performance for a given ad campaign;
at least one analytics module for computing relative performance of each subcomponents and providing data to said matching engine and said optimization module to achieve performance improvements;
a least one listing platform module for preparing acquired content for dynamic ad serving by injecting said acquired content into said matching engine module; and
at least one module for enabling scalable operation of said dynamic ad serving platform.

6. The dynamic ad serving platform of claim 5, further comprising:
at least one load-balancing module for shunting load coming from ad impression requests to one of a plurality of ad servers in a cluster of parallel ad serving computers.

7. The dynamic ad serving platform of claim 5, further comprising:
at least one presentation layer reside on a stateless server for processing incoming requests without preserving stat from one request to another.

8. The dynamic ad serving platform of claim 5, further comprising an ad serving decision engine.

9. The dynamic ad serving platform of claim 5, further comprising:
at least one listing server for retrieving content from a content repository that is appropriate for a given advertiser campaign;
at least one listing database for persistently storing campaign business rules and logical associations of creative assets, placements and listings.

10. The dynamic ad serving platform of claim 5, wherein said at least one module for enabling scalable operation of said dynamic ad serving platform comprises one or more modules for any of:
aiding creative designers and developers to build dynamic advertising templates for ad construction;
allowing media and creative designers to author business rules that govern campaigns and creating one tag per size that gets trafficked into the base and server platform;
allowing for visualization of data that is produced from said at least one analytics module.

11. The dynamic ad serving platform of claim 5, wherein said acquired content comprises any of:
business rules;
real-time feeds; and
media assets.

12. The dynamic ad serving platform of claim 5, wherein said platform is operative to distribute constructed advertisements into different channels of distribution, said channels of distribution comprising any of:
banner advertising across public networks
social network sites and the types of advertising that are support by said social network sites that are different from said banner advertising;
advertising to be shown to mobile phone users; and
advertising that accompanies online videos as in pre-roll, mid-roll and post-roll video placements.

13. A computer program product comprising:
at least one computer-readable storage medium having embodied thereon computer-readable instructions which, when executed, implement a dynamic ad server comprising:
at least one module for constructing an ad experience dynamically by assembling subcomponents of an ad on the fly;
at least one module for selecting said subcomponents at the time an ad impression is to be served, based on at least one of: publisher, user and media parameters submitted to the ad server; and
at least one business rules engine for processing natural-language marketing rules specifying said parameters; and
at least one module for designing and implementing a campaign wherein association of placements to creative tags is limited to a single tag per size per campaign for an entire media plan.

14. A computer program product comprising:
at least one computer-readable storage medium having embodied thereon computer-readable instructions which, when executed, implement a dynamic ad serving platform comprising:
a content acquisition module for acquiring content from outside the serving environment;
at least one ad server, the ad serving comprising a matching engine module for accepting incoming media and audience parameter, applying business rules and selecting listing and creative sub-components that form the elements of the ad experience;
at least one ad construction module for assembling ad experiences on-the-fly and laying them out to conform to campaign specifications for rendering on a user's web browser;
at least one optimization module for selecting a set of components likely to product best performance for a given ad campaign;
at least one analytics module for computing relative performance of each subcomponents and providing data to said matching engine and said optimization module to achieve performance improvements;
a least one listing platform module for preparing acquired content for dynamic ad serving by injecting said acquired content into said matching engine module; and
at least one module for enabling scalable operation of said dynamic ad serving platform.

15. A computer-implemented method for dynamically generating an advertising creative experience by an ad server comprising the steps of:
via a computational device, assembling different subcomponents of an ad on-the-fly to dynamically construct said ad experience;
via a computational device, selecting said subcomponents that need to be assembled based on any of publisher, user and media parameters submitted to the ad server at the time an ad impression is to be served;
via a computational device, processing natural-language marketing rules specifying said parameters; and
via a computational device, designing and implementing a campaign wherein association of placements to creative tags is limited to a single tag per size per campaign for an entire media plan.

16. A computer-implemented method for designing an online ad campaign comprising the steps of:
via a computational device, creating data and asset feeds;
via a computational device, submitting said data and asset feeds to an ad delivery platform;
via a computational device, authoring marketing rules;
via a computational device, submitting said marketing rules to said ad delivery platform;
via a computational device, receiving a single ad tag per size per campaign from said ad delivery platform;
via a computational device, set up a plurality of ad tags as smart creative tags in an ad server within said ad delivery platform; and
via a computational device, associating a single ad tag per size per campaign.

17. A computer program product comprising at least one computer-readable storage device having computer-readable code embodied thereon for performing the steps of a method for dynamically generating an advertising creative experience by an ad server, the method comprising the steps of:
assembling different subcomponents of an ad on-the-fly to dynamically construct said ad experience;
selecting said subcomponents that need to be assembled based on any of publisher, user and media parameters submitted to the ad server at the time an ad impression is to be served;
processing natural-language marketing rules specifying said parameters; and
designing and implementing a campaign wherein association of placements to creative tags is limited to a single tag per size per campaign for an entire media plan.

18. A computer program product comprising at least one computer-readable storage medium having embodied thereon computer-readable instructions for performing steps of a method for designing an online ad campaign, the method comprising the steps of:
creating data and asset feeds;
submitting said data and asset feeds to an ad delivery platform;
authoring marketing rules;
submitting said marketing rules to said ad delivery platform;
receiving a single ad tag per size per campaign from said ad delivery platform;
set up a plurality of ad tags as smart creative tags in an ad server within said ad delivery platform; and
associating a single ad tag per size per campaign.
